(19) United States
(12) Patent Application Publication
(10) Pub. No.: US 2019/0024422 A1
(43) Pub. Date: Jan. 24, 2019

(54) HANDLING A MOTOR VEHICLE DOOR HANDLE

(71) Applicant: Kiekert AG, Heiligenhaus (DE)

(72) Inventors: Ömer INAN, Dorsten (DE); Carsten FUCHS, Essen (DE); Uwe REDDMANN, Essen (DE); Johannes Theodor MENKE, Velbert (DE)

(73) Assignee: Kiekert AG, Heiligenhaus (DE)

(21) Appl. No.: 15/757,668

(22) PCT Filed: Sep. 7, 2016
(86) PCT No.: PCT/DE2016/100414

§ 371 Date: Mar. 6, 2018

(30) Foreign Application Priority Data
Sep. 10, 2015 (DE) 10 2015 115 221.5

(51) Int. Cl. E05B 81/90; E05B 85/16; E05B 77/12; E05B 81/76

(52) U.S. Cl. CPC E05B 81/90; E05B 85/16; E05B 79/20; E05B 81/76; E05B 77/12

(57) ABSTRACT

The invention relates to a device for opening (1) a door or flap on a motor vehicle (8), in particular a door handle for a motor vehicle (8), having a grip part (2), wherein the grip part (2) is accommodated so as to be movable on one side, a means for detection (2) of the movement of the grip part (2), and a means for limiting the movement (3) of the grip part (2), wherein the means for limiting the movement (3) of the grip part (2) is movable out of the engagement region of the grip part (2).

The invention relates to a device for the opening of a door or flap on a motor vehicle, in particular a door handle for a motor vehicle, having a handle section, where the handle section is accommodated movable on one side, a means for detecting the movement of the handle component and a means for limiting the movement of the handle section.

Motor vehicles are now increasingly equipped with comfort functions. Electrically operated sliding doors, closure aids and/or electrical latches are to be mentioned in this regard, for example. Electrical latches, so-called e-latches are used if the latching systems or the latches of the motor vehicles are equipped with electrical devices to open the latching system. By means of an electrical drive in the latching system a locking mechanism formed from a catch and a pawl, for example, can be electrically unlocked. No mechanical connection is required between, for example, an external door handle and the latching system. For this purpose, the latching system has an electrical transducer which in turn detects whether the latching system should be opened. If an opening command from the door handle reaches the latching system, a mechanism is set in motion, usually electrically, which causes unlocking of the unlocking of the locking mechanism of the latching system. The door, flap or sliding door can thus be opened very easily and conveniently.

In order to still be able to open the door latch in the case of a power drop, the opening devices are usually equipped with a mechanical means with which opening can also take place when no power supply is available for the door latch to be operated electrically.

A handle section to open an electrically operated door latch is known from DE 196 42 698 C2, for example. A solution in which a movably accommodated handle section is firmly connected to the chassis of a motor vehicle is disclosed as an example, whereby the handle section also has a pressure switch with which the door latch can be opened. The handle section is firmly attached adjacent to the outer shell of the motor vehicle in customary operation, i.e. when battery voltage is available.

If, in the case of an accident, a power drop occurs, an electromagnet is operated which in turn moves a locking bolt, so that a pivoting lever is released which in turn releases a gearwheel to which a Bowden cable is connected. The Bowden cable connected to the gearwheel is mechanically connected to the door latch so that pulling can take place on the Bowden cable during movement of the gearwheel. The gearwheel interacts with a gear rack which is attached to the handle section in turn. If a power drop now occurs, the gearwheel is released and the operator can remove the handle section by pivoting from the outer shell of the motor vehicle, whereby the gear rack combs into the gearwheel and pulls on the Bowden cable. A mechanical operation of the latch is therefore available in an emergency.

A further handle device to open an electrical latch is known from DE 10 2006 029 774 A1. A handle element movable on one side is arranged in a fixed handle section. A sensor is located inside the handle element with which a signal can be transmitted to the latch, so that an opening command can be transmitted to the latch during grasping of the handle element. The handle element needs not be moved to operate the electrical latch. However, in the case of a power drop a mechanical operation of the latch is provided for. The handle element arranged in a mobile manner interacts with a force locking unit which needs to be overcome in order to activate the mechanical connecting element to the latch. The force locking unit can be a pressure spring or a ratchet connection, for example.

The disadvantage of the handle devices known from the state of the art is, on the one hand, the lack of permanent movement of the handle section, so that it remains questionable whether the emergency mechanism will actually activate this after years of non-operation and, on the other hand, with the mere existence of a force locking unit whether this retains its full function over the duration of operation. It is thus problematic that, on the one hand, malfunctions can arise by means of non-operation and, on the other hand, in the case of constant movement superordinate signals can occur for the latch, whereby the operator transmits electrical and mechanical signals to the door latch.

The task of the invention is to provide an improved handle device to open a door or a flap. Another task of the invention is to provide a device, in particular a handle device, to open a door or a flap on a motor vehicle, which attains a maximum amount of safety and in which safe opening of the latch can be guaranteed in the case of a power outage. Another task of the invention is to provide a structurally simple and cost-effective option to open a door or a flap for the operation of electrical latches.

According to the invention, the task is solved by the characteristics of independent patent claim 1. Advantageous embodiments of the inventions are specified in the sub-claims. It is pointed out that the exemplary embodiments described hereafter are not restrictive; instead, any possible variations are possible of the characteristics described in the description and the sub-claims.

According to patent claim 1, the task of the invention is solved by a device for the opening of a door or flap on a motor vehicle, in particular a door handle for a motor vehicle being provided having a handle section, whereby the handle section is accommodated movable on one side, a means for detecting the movement of the handle section and a means for limiting the movement of the handle section, where the means for limiting the movement of the handle section can be moved out of the engagement area of the handle section. The formation of the device or handle device according to the invention now creates the possibility of overcoming the disadvantages from the state of the art and providing an improved handle device. The handle section remains constantly mobile, while a handle path limitation can be specified. Due to the continual movement of the handle section, furthermore the risk no longer exists of the handle section not being movable in an emergency following years of fixing of the handle section.

Furthermore, the means for limiting the movement of the handle section lies adjacent on the handle section so that a firm stop is available for the handle section. This simultaneously creates a haptic advantage, where the operator experiences clear feedback that the door latch has been properly operated. The firm stop for the door handle can also simultaneously serve to open the door uniformly and forcefully for the operator. The disadvantage of the state of the art is also hereby overcome that in the case of a spring accommodation for the handle section no identical haptic feedback is available to the operator. The handle section could pivot in the handle accommodation. These disadvantages are overcome by the firm stop for the mobile handle section according to the invention.

Due to the continual movement of the handle section, the handle section remains mobile and a mechanical connecting element which is attached to the handle section is continually moved. A ratcheting in or fixing can thus be prevented.

If a device to open a door or flap of a motor vehicle is spoken of for the purpose of the invention, this predominantly includes a door handle or flap handle or a sliding door handle. However, the invention is not restricted to those components, but can also relate to covers, for example for a cabrio roof. The solution according to the patent claim relates to an opening device for motor vehicle components which are equipped with electrical latches. A handle section is used which can generate an electrical signal so that by means of a detection means the latch can receive a control signal in order to activate the electrical opening mechanism.

Advantageously the handle section is accommodated pivotable on one side. This is especially advantageous as the operator experiences haptic feedback by means of a pivoting movement that he has transmitted an opening command to the latch. A means for detection of the movement of the handle section can be a sensor and preferably a capacitive sensor, for example. However, mechanical switching means and/or optical sensors can also be used as sensors to detect the movement of the handle section. A mechanical stop can serve as a means to limit the movement of the handle section, for example. As a path-limiting means, the mechanical stop is movably arranged so that the path limiting means can be moved outside of the engagement area of the handle section.

In one embodiment of the invention an advantage results if the means to limit the movement of the handle section interacts directly with the handle section. A direct engagement of the path limiting means into the handle section offers the advantage that a structurally simple solution can be provided. Furthermore, the structurally simple solution of the direct engagement offers the advantage that the device can be configured for opening at low tolerances. Direct interaction between the path limiting means and the handle section can be formed in a form-fitting manner, for example. Cooperating structural forms can be formed between the handle section and the path limiting means.

An advantageous configuration results if the movement limiting means can be moved out of an engagement area of the handle section. An especially simple structural configuration of a path limiting means for the device is attained by a path limiting means is attained by a path limiting means which, in terms of backwards and forwards movement, retracts into the handle section and can be moved out of the handle section in the case of a power outage. With voltage applied, the path measuring means is thus in a movement area of the handle section and reduces the stroke of the handle section such that only the detection means can be controlled to record the movement of the handle section. The path limiting means thus limits the stroke of the handle section such that a control signal can be generated by means of a detection means; however, the stroke is not sufficient to enable mechanical opening of the latching system. Moving out is also easy to implement from a structural perspective.

As an example, in one embodiment of the invention the movement limiting means can be moved from the engagement area of the handle section by means of a linear movement. A linear movement can be retracted into the handle section, for example, by means of a sliding element which is accommodated in a motor vehicle chassis in a linear shifting manner, for example. This can be achieved by means of a lifting cylinder and/or an electrical drive with a tappet, for example. Electrical means to attain a linear movement are cost-effective and simple to configure from a structural perspective. A drive with only two end positions is especially cost-effective to execute in particular. Two end positions hereby means a position of the path limiting means retracted in the handle and a further end position of the path limiting means moved out of the movement area of the handle section.

A further example of an embodiment results if the movement limiting means can be moved out of the engagement area of the handle by means of a pivoting movement. A rotating or pivoting movement of the path limiting means also enables disengagement of the path limiting means with the handle section, even for the slightest pivoting movements. Pivoting movements are also very easy to produce. The path limiting means can thus be installed directly on an axis of the electromotor, for example. Two stops on the path limiting means can then serve as end stops for a control of the motor simultaneously. An extremely cost-effective solution for path limiting could thus be achieved. It is furthermore also conceivable that the path limiting means can be moved manually in a linear and a pivoting form from the engagement area of the handle section. Only the path limiting means needs to be directly or indirectly moved out of the engagement area of the handle section. It thus becomes clear that a multitude of solutions for moving the path limiting means out of the engagement area of the handle section are available. It is crucial for the invention that the path limiting means interacts with the handle section such that a lifting movement of the handle section is enabled.

In an advantageous embodiment of the invention the handle section can be connected to a latch by means of a mechanical connecting element. In order to produce a mechanical connection between the handle section and the latch in the motor vehicle, it is advantageous to arrange a mechanical connecting element, in particular a Bowden cable, between the handle section and the latch. A Bowden cable can be suspended on one hand in the handle section, for example, and on the other hand in an operating lever of the latch. In the case of movement of the handle section, a movement can then be transmitted to the latch by means of the Bowden cable. If voltage is applied, the handle section is limited in lifting. The Bowden cable is only moved briefly and over a short distance when the handle section is operated. The latch is operated by means of the Bowden cable but not operated so far that an opening of a locking mechanism inside the latch can be enabled. The opening takes place by means of detection of the short stroke of the handle section and by means of an electrical drive, for example, which removes the pawl from the engagement area of the catch.

Advantageously the latch can only be operated by means of the handle section if the movement limiting means of the handle section can be moved out of the engagement area of the handle section. By means of the mechanical connection between the handle section and the latch the handle section can only be moved in parts when voltage is applied. If a voltage drop occurs, as during an accident or decreasing battery voltage, for example, the path limiting means is thus moved out of the engagement area of the handle section. If the path limiting means is moved out of the engagement area of the handle section, the path limiting for the handle section is thus lifted and the handle section can be moved by means of a greater stroke. The stroke is so great in particular that unlocking of the locking mechanism can occur by means of the mechanical connecting means.

In a preferred embodiment the handle section has a stroke of 1-5 mm, preferably 1-3 mm in the case of a limited lifting movement. In the case of an unlimited lifting movement, the handle section has a stroke of 10-40 mm, preferably 15-40 mm and, even more preferably, a stroke of 25-35 mm. When the voltage is applied, only a short stroke is provided and in the case of a power drop in which the path limiting means was moved out of the engagement area of the handle section, a long stroke is provided for the handle. In both cases, the handle section moves as a pivoting movement.

Advantageously, the movement limiting means of the handle section can be moved out of the engagement area of the handle section in the case of a power drop and/or in the case of accident. The path limiting means is activated on a threshold value, for example in the case of a drop in power so that sufficient power is still available to operate the path limiting means in order to thus enable safe mechanical opening of the latch.

The invention is described in further detail below with reference to the attached drawings on the basis of preferred exemplary embodiments. However, the principle applies that the exemplary embodiments do not restrict the invention, but only constitute advantageous embodiments. The characteristics portrayed can be executed individually or in combination with other characteristics of the description and also the patent claims individually or in combination.

The following are shown:

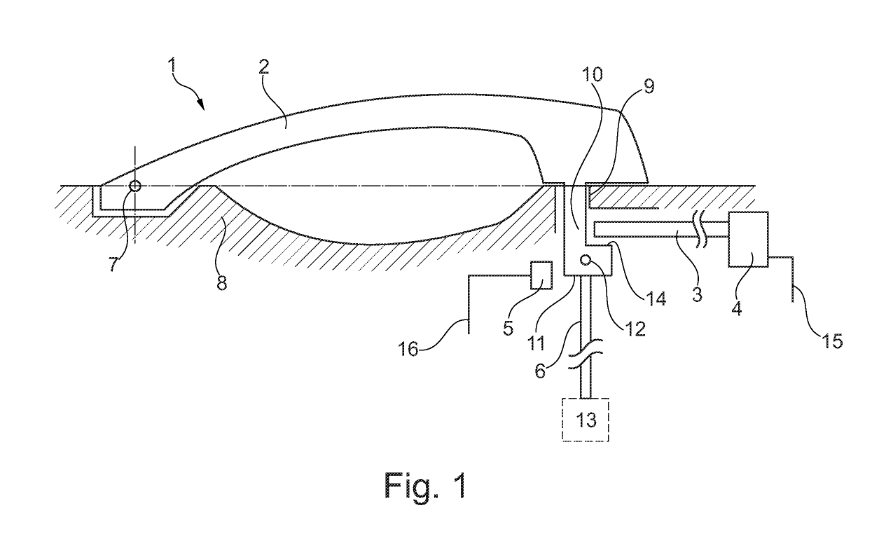

FIG. 1 a device to open a door or flap on a motor vehicle in the form of a door handle in a cross-section through a motor vehicle with a basic representation of a path limiting means,

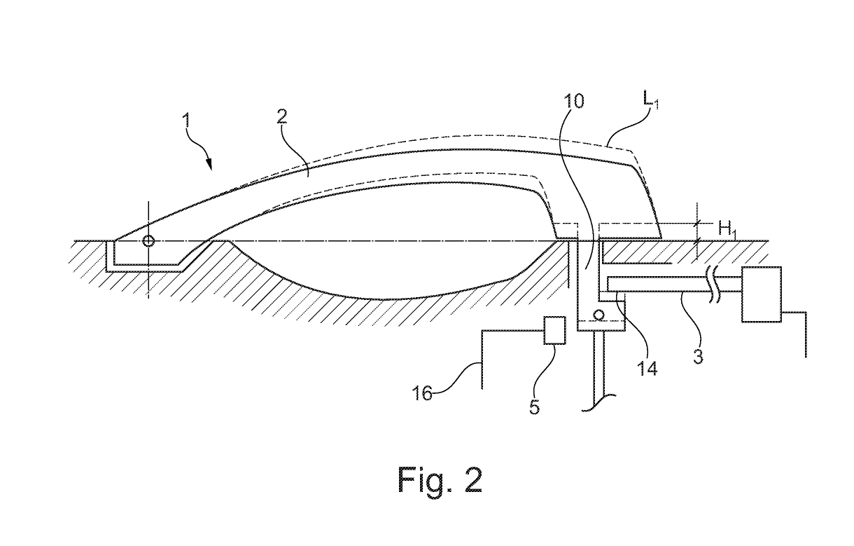

FIG. 2 the device according to FIG. 1, whereby the door handle was moved to operate the electrical latch and reaches the stop against the path limiting means, and

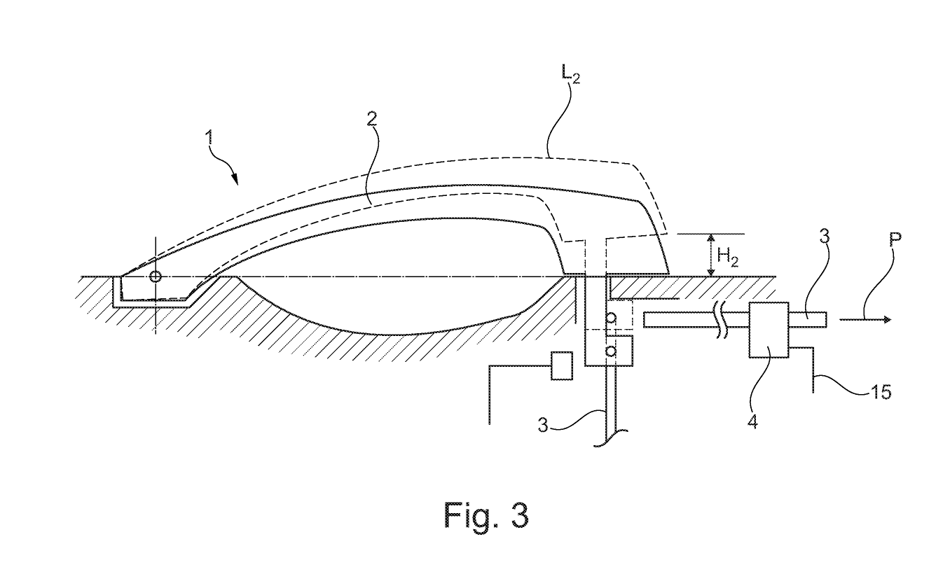

FIG. 3 the door handle according to FIG. 1, whereby additionally the position of the door handle is illustrated during mechanical operation of the latch and the path limiting was moved from the engagement area of the door handle.

A device to open a door or flap is reproduced in a sectional view in FIG. 1. The device 1 encompasses a handle section 2, a path limiting means 3, a drive unit 4, a sensor element 5 and a mechanical connecting means 6. The handle section 2 is pivotably accommodated around the bearing point 7 in a chassis component 8.

In this exemplary embodiment, the chassis component 8 has an opening 9 through which an extension 10 reaches on the handle section 2. An attachment means 12 for the Bowden cable 6 is arranged on an end 11 of the extension 10 reaching into the chassis component 8. A mechanical connection thus exists between the handle section and the mechanical connecting means 6 which can be a Bowden cable, for example. The mechanical connecting means 6 is connected to an operating lever in the latch so that the latch can be mechanically opened. The mechanical connection to the latch 13 is only reproduced schematically in FIG. 3.

The extension 10 on the handle section 2 is enlarged in the area of the connection to the attachment means 12 so that a stop surface 14 results. The widened formation of the extension 10 shall only explain the systematic function of the opening device, while naturally also an engagement of the path limiting means 3 is possible directly into the extension 10. Thus, for example, the extension 10 can have a boring or a passage opening which then interacts as a lengthwise hole with the path limiting means 3, for example. However, the basic representation of the function of the path limiting means in FIG. 1 clearly shows the interplay between the path limiting means 3 and a possible stop surface 14 on the handle section 2. The sensor element 5 and the drive unit 4 are connected to a non-illustrated control unit by means of electrical cables 15, 16 so that, on the one hand, detection of a movement of the handle section can be recorded and, on the other hand, an operation of the path limiting means 3 is enabled.

The opening device 1 according to FIG. 1 is illustrated in turn in FIG. 2. The stroke H1 of the handle section 2 is also illustrated with a dot-dashed line L1. During movement of the handle section 2 around the stroke H1 the extension 10 also moves around the path H1 and reaches against the path limiting means 3 with the stop surface 14. The stroke H1 of the handle section 2 is thus limited by the path limiting means 3, so that only a very small stroke H1 of 2-3 mm, for example, is enabled. The sensor element 5 detects the stroke H1 and transmits a control signal to the control by means of the electrical cable so that the electrical latch 13 can receive a signal to opening a locking mechanism.

If, as a result of an accident, for example, a power drop now occurs in the motor vehicle, the control unit transmits a signal to the drive unit 4 by means of the electrical cable 15, whereby the path limiting means 3 is moved out of the engagement area of the handle section 2. In the present exemplary embodiment, the path limiting means executes a linear movement in the direction of the arrow, whereby the drive means can be an electrical drive with a gearwheel, for example, which engages directly into an interlocking of the path limiting means 3. By means of movement of the path limiting means 3 from the engagement area of the handle section 2 the handle section 2 can now be pivoted into the position illustrated as dot-dashed line L2. The handle section 2 can accomplish a greater stroke H2 of 25-30 mm, for example. The stroke H2 is sufficient to mechanically open the latch 13 by means of the mechanical connecting means 3.

By means of the formation of the opening device 1 according to the invention, the possibility is thus created of arranging a handle section 2 which is pivotable in the motor vehicle 8 at all times and also in the case of a power drop, to guarantee safe mechanical opening.

### LIST OF REFERENCE SYMBOLS

1 Opening device
2 Handle section
3 Path limiting means
4 Drive unit
5 Sensor element
6 Mechanical connecting means
7 Bearing point
8 Chassis component
9 Opening
10 Extension
11 End of extension
12 Attachment means
13 Latch
14 Stop surface
15, 16 Electrical cables
L1, L2 Dot-dashed line
H1, H2 Stroke
P Arrow

1. An opening device for a door or flap on a motor vehicle, in particular a door handle for a motor vehicle, comprising
a handle section, the handle section being movable on one side,
a sensor for detecting movement of the handle section, and
a means to limit the movement of the handle section, wherein the means for limiting the movement of the handle section can be moved out of an engagement area of the handle section.

2. The opening device according to claim 1, wherein the means for limiting the movement of the handle section interacts directly with the handle section.

3. The opening device according to claim 1, wherein the means for limiting the movement can be moved out of an engagement area of the handle section.

4. The opening device according to claim 1, wherein the means for limiting the movement can be moved out of the engagement area of the handle section by means of a linear movement.

5. The opening device according to claim 1, wherein the means for limiting the movement can be moved out of the engagement area of the handle section by means of a pivoting movement.

6. The opening device according to claim 1, wherein the handle section can be connected to a latch by means of a mechanical connecting element.

7. The opening device according to claim 6, wherein the latch can only be operated by means of the handle section, if the means for limiting the movement of the handle section is moved out of the engagement area of the handle section.

8. The opening device according to claim 1, wherein the handle section has a stroke of 1 mm to 5 mm, preferably 1 to 3 mm in the case of a limited stroke movement.

9. The opening device according to claim 1, wherein the handle section has a stroke of 10 mm to 40 mm, preferably 15 to 40 mm and even more preferably a stroke of 25 mm to 35 mm in the case of an unlimited stroke movement.

10. The opening device according to claim 1, wherein the means for limiting the movement of the handle section can be moved out of the engagement area of the handle section in the case of a drop in the power supply and/or in the case of accident.
